(19) United States
(12) Patent Application Publication
(10) Pub. No.: US 2003/0005659 A1
(43) Pub. Date: Jan. 9, 2003

(54) Buck system for concrete structures

(76) Inventor: James D. Moore, JR., Fort Lauderdale, FL (US)

Correspondence Address: MERCHANT & GOULD PC, P.O. BOX 2903, MINNEAPOLIS, MN, 55402-0903, US

(21) Appl. No.: 10/190,068

(22) Filed: Jul. 5, 2002

Related U.S. Application Data
(60) Provisional application No. 60/303,669, filed on Jul. 6, 2001.

(51) Int. Cl. E06B 7/08

(52) U.S. Cl. 52/473

(57) ABSTRACT

A buck system for forming a frame to insert a window, door, or the like into a wall. The buck system includes assembly members that have a width that corresponds to the dimension of the cavity, if any, and optionally includes end caps. The assembly members and end caps are preferably formed of materials that avoid the drawbacks of dimensional lumber. It is noted that this abstract is provided to comply with the rules requiring an abstract that will allow a searcher or other reader to ascertain quickly the subject matter of the technical disclosure. The abstract is submitted with the understanding that it will not be used to interpret or limit the scope or meaning of the claims pursuant to 37 C.F.R. §1.72(b).

This patent application claims priority to U.S. Provisional Application Serial No. 60/303,669, which was filed on Jul. 7, 2001, and which is fully incorporated herein by reference.

### BACKGROUND OF THE INVENTION

1. Field of the Invention

The present invention encompasses a system and method for forming openings within and through a wall, particularly walls formed at least in part with concrete. The openings later serve as frames to install a door, a window, or the like.

2. Background

Concrete walls in building construction are often produced by first setting up two parallel form walls and placing fluid concrete into the space between the forms. After the concrete hardens, the builder then removes the forms, leaving the cured concrete wall.

This prior art technique has drawbacks. Formation of the concrete walls is inefficient because of the time required to erect the forms, wait until the concrete substantially cures, and take down the forms. This prior art technique, accordingly, is an expensive, labor-intensive process.

Techniques have developed for forming modular concrete walls that use a foam insulating material. The modular form walls are set up parallel to each other and connecting components hold the two form walls in place relative to each other while concrete is poured therebetween. The form walls, however, remain in place after the concrete cures. That is, the form walls, which are often constructed of foam insulating material, are a permanent part of the building after the concrete cures. The concrete walls made using this technique can be stacked on top of each other many stories high to form all of a building's walls. In addition to the efficiency gained by using the form walls in construction and also using them as part of the permanent structure, the materials of the form walls often provide adequate insulation for the building.

When constructing such form walls, it is frequently desired to position windows, doors, garage doors, or other opening through the wall between the interior and exterior of the building. The typical prior art procedure for forming an opening involves constructing a frame from dimensional lumber and positioning the wood frame within and between the opposed pair of insulated concrete forms. The wood frame is sized to receive a structure of a desired dimension and then the frame is positioned within and through the pair of modular form walls, after which time the concrete is poured between the forms to circumscribe the exterior of the wood frame. When the concrete substantially cures, the wood forms are either removed so that the desired structure may be inserted into and through the opening formed within the wall structure or, more typically, remain in place and serve as the frame into which the structure, such as a window, is inserted.

There are disadvantages with using dimensional lumber to form these openings however. The primary drawback is that even if the wood is initially straight, warping often occurs when the fluid concrete contacts the lumber during the construction of the wall. The result is that the opening left after the wood warps is not of the proper dimension to receive the desired structure, such as the window, resulting in the structure not fitting correctly within the opening. Such an improper fit mandates that the opening be re-dimensioned, which may include leveling some of the wood that extends too far into the opening or adding an appropriate filler if the opposite condition exists. Reworking the dimensions of the opening obviously is labor intensive—which increases costs—and also delays completion of the building.

Even if the dimensional lumber does not warp during the construction phase (e.g., it is covered with a polyfilm before pouring the concrete), the wood is still subject to aging and the associated problems. For example, the wood may later warp, which may potentially cause buckling and cracking of the wall adjacent the wood. Other possible problems are rot, decay, and insect damage. These problems have resulted in some contractors having reservations about constructing concrete buildings using insulating concrete forms when openings are included in the design.

One attempt to address the problems associated with using wood frames is disclosed in U.S. Pat. No. 6,070,375, which is incorporated herein in its entirety. This patent teaches a buck system for forming openings in concrete walls using a vinyl material to overcome the deficiencies with using dimensional lumber. However, the disclosed process currently has not been embraced by the industry.

### SUMMARY OF THE INVENTION

The present invention provides a plurality of assembly members formed of a non-wood material, such as polyvinyl chloride (“PVC”). Each assembly member, however, can be used similar to dimensional lumber so that builders are comfortable with its use. That is, the assembly members of the present invention may be used in the same manner as dimensional lumber to facilitate acceptance in the industry, but avoid the drawbacks of wood, such as warping, decay, rot, insect damage, or the like.

In addition, the assembly members of the present invention may be used in conjunction with interlocking end caps and, collectively, be formed to an appropriate depth to match any standard dimension wall. In the preferred embodiment, the end caps have the same depth or thickness as the side panels and the assembly members are formed to be the same depth as the cavity into which the fluid concrete is poured during construction. The components are formed in select sizes so that they can be combined to form walls in almost any standard dimension. As such, the preferred embodiment of the present invention is “modular” by minimizing the number of different components, yet is still able to combine for any standard construction design.

### BRIEF DESCRIPTION OF THE FIGURES OF THE DRAWINGS

FIG. 1 is a perspective view of a one embodiment of a wall formed using insulated concrete forms to provide context for the present invention.

FIG. 2 is a perspective side view of a FIG. 1 taken along line 2-2.

FIG. 2A is an alternative view of FIG. 2 showing concrete disposed between the two opposed side panels.

FIG. 3 is a perspective view of one side panel shown in FIG. 1.

FIG. 4 is a perspective view of a connector shown in FIG. 3.

FIG. 5 is an exploded perspective view of a web member showing an extender.

FIG. 6 is a perspective view of one embodiment of the assembly member of the present invention.

FIG. 7 is a cross-sectional end view of the assembly member shown in FIG. 6 interconnected to two end caps on its opposed sides.

FIG. 8A is a perspective view of the assembly members and end caps, similar to those shown in FIG. 7, that are inserted into the insulated concrete forms shown in FIG. 1 to form a frame for a window.

FIG. 8B is a vertically cut cross-sectional perspective view of FIG. 8A.

FIG. 8C is a side end view of FIG. 8B.

FIG. 8D is a horizontally cut cross-sectional perspective view of FIG. 8A.

FIG. 8E is a top plan view of FIG. 8D.

FIG. 9A is a perspective view of the assembly members and end caps, similar to those shown in FIG. 7, that are inserted into the insulated concrete forms shown in FIG. 1 to form a frame for a hinged door.

FIG. 9B is a perspective view of FIG. 9A a vertically cut cross-sectionally without the bottom member shown in FIG. 9A.

FIG. 9C is an end view of FIG. 9B.

FIG. 9D is an end view of FIG. 9A.

FIG. 10 is a cross-sectional side view showing the buck system of FIG. 7 and also showing two opposed side panels and the web members partially disposed therein, in which the buck system and side panels are interconnected in various combinations by flexible linking members traversing through extenders or slots.

### DETAILED DESCRIPTION OF THE INVENTION

The present invention is more particularly described in the following examples that are intended as illustrative only since numerous modifications and variations therein will be apparent to those skilled in the art. As used in the specification and in the claims, “a,” “an,” and “the” can mean one or more, depending upon the context in which it is used. The preferred embodiment is now described with reference to the figures, in which like numbers indicate like parts throughout the figures.

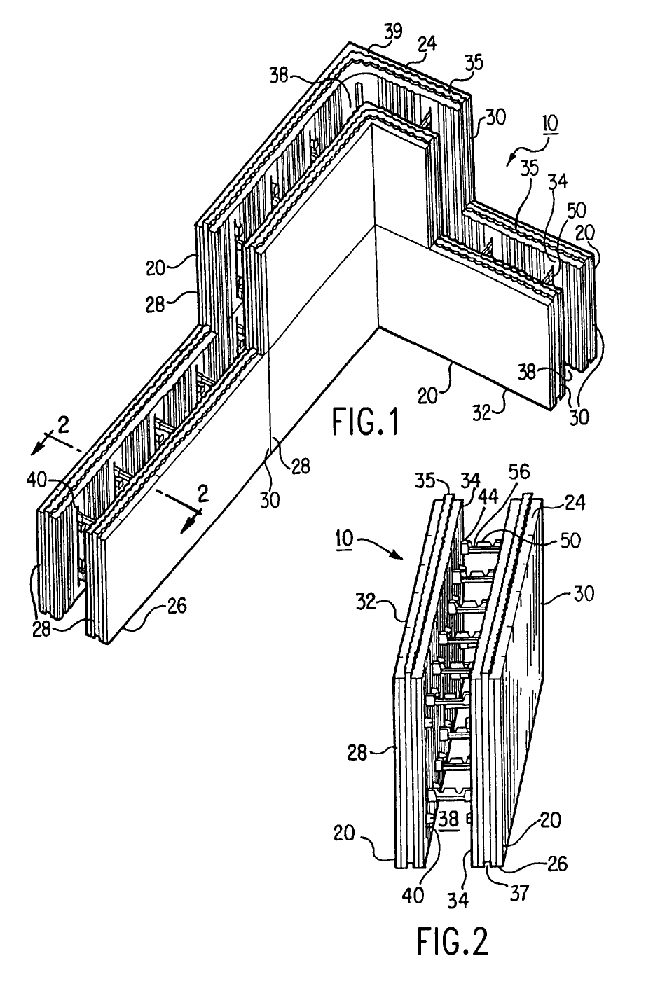

As generally shown in FIGS. 1-10, the preferred embodiment of the present invention comprises a buck system used in conjunction with a concrete form structure. Before describing the buck system, it is instructive to discuss one exemplary embodiment of an insulated concrete form system with which the buck system of the present invention may be used. As those skilled in the art will appreciate, the described insulated concrete form is exemplary to provide context in discussing the buck system of the present invention, and the buck system may be used with other insulated concrete forms within the scope of the present invention.

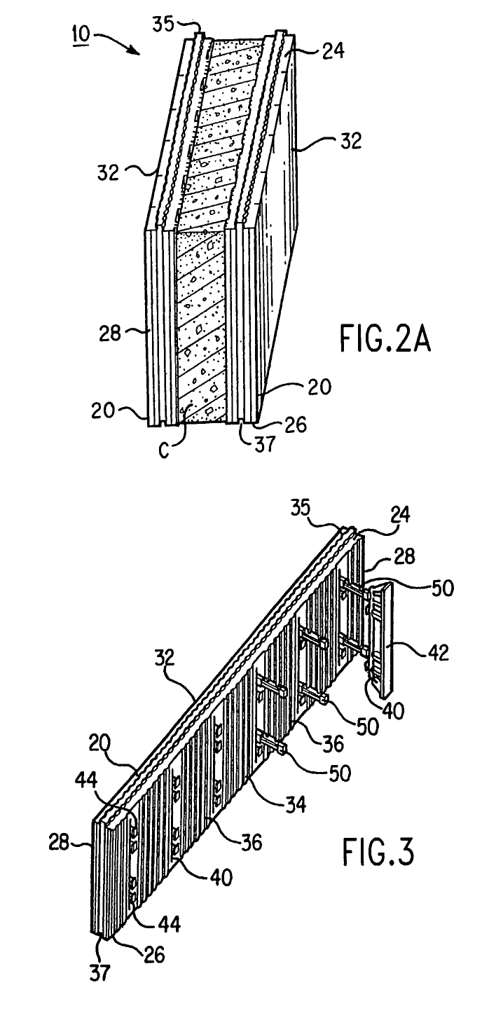

Specifically, one concrete form system 10 is shown best in FIGS. 14 and includes at least two opposed longitudinally-extending side panels 20, at least one web member 40 partially disposed within each of the side panels 20, and a connector 50 disposed between the side panels 20 for connecting the web members 40 to each other. As shown in FIG. 2A, concrete C is poured between the side panels 20 so that it bonds with the side panels 20, the web members 40, and the connectors 50. A more complete discussion of this and other designs are disclosed in U.S. Pat. No. 6,363,683 and pending U.S. patent application Ser. No. 09/848,595, filed on May 3, 2001, the disclosures of which are incorporated by reference in their entireties.

Each side panel 20 has a top end 24, a bottom end 26, a first end 28, a second end 30, an exterior surface 32, and an interior surface 34. The illustrated side panel 20 has a thickness (separation between the interior surface 34 and exterior surface 32) of approximately two (2) inches for commercial construction and two and a half (2 ½) inches for residential buildings, a height (separation between the bottom end 26 and the top end 24) of twenty-four (24) inches for commercial buildings and sixteen (16) inches for residential buildings, and a length (separation between the first end 28 and second end 30) of forty-eight (48) inches. Of course, these dimensions are exemplary and may be altered, if desired, or may be different in other form systems with which the present invention may be used.

Referring still to FIGS. 1 and 2, the interior surface 34 of one side panel 20 faces the interior surface 34 of another side panel 20 and the opposed interior surfaces 34 are laterally spaced apart from each other a desired separation distance so that a cavity 38 is formed therebetween. Concrete—in its fluid state—is poured into the cavity 38 and allowed to substantially cure (i.e., harden) therein to form the wall 10, as shown in FIG. 2A. Preferably the opposed interior surfaces 34 are parallel to each other. The side panels 20 are typically constructed of polystyrene, specifically expanded polystyrene (“EPS”), which provides thermal insulation, sound impedance, and sufficient strength to hold the poured concrete C until it substantially cures. As shown in FIGS. 1-3, each side panel 20 shows six web members 40 formed into it. Portions of each web member 40 that extend through the interior surface 34 of the side panel 20 form one or more attachment points 44. The attachment points 44 are disposed within the cavity 38 and are spaced apart from the interior surface 34 of the side panels 20 in the illustrated embodiment.

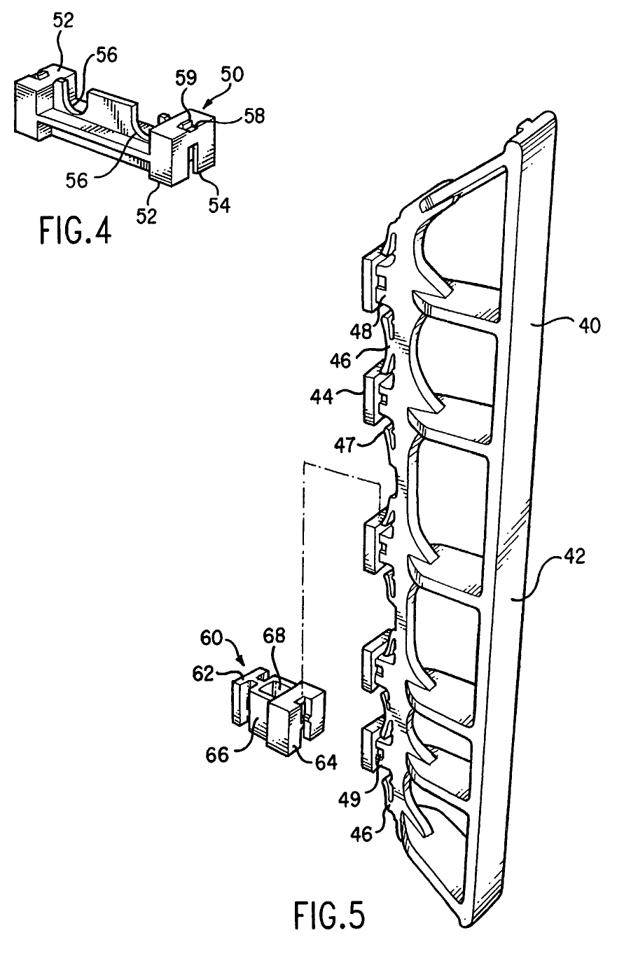

Each attachment point 44 is sized to be complementarily and slidably received within one respective end 52 of the connector 50, which is best shown in FIG. 4. The connectors 50 engage two attachment points 44 on opposed web members 40, which position the interior surfaces 34 of the side panels 20 at a desired separation distance. That is, still referring to FIG. 4, the illustrated connector 50 has opposed ends 52 and a length extending therebetween. The ends 52 of the connectors 50 are each of a shape to engage one attachment point 44 of two respective web members 40 within opposed panels. Thus, the connectors 50 space the side panels apart from each other so that the web members 40 preferably do not directly contact each other; instead, each attachment point 44 independently engages the connector 50 that interconnects the web members 40 and, accordingly, the side panels 20. The connection between the connectors 50 and the opposed web members 40 are sufficient to hold and support the side panels 20 as they are subject to hydrostatic and dynamic forces when the fluid concrete is poured into the cavity 38 during construction.

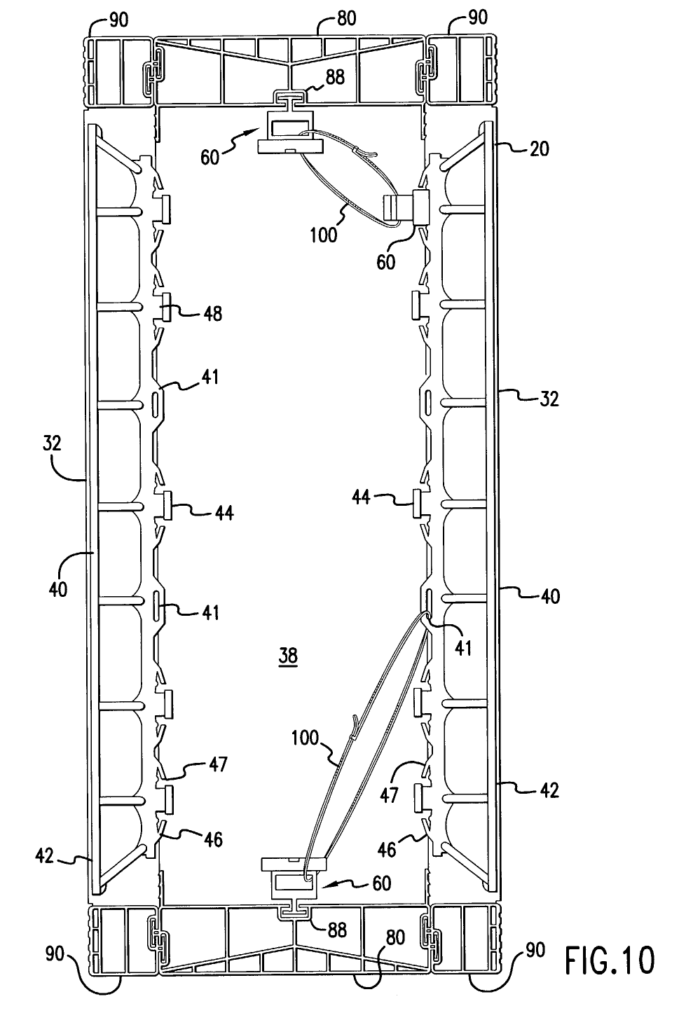

As best shown in FIGS. 2 and 3, in one design each of the web members 40 has four spaced-apart attachment points 44, in which the attachment points 44 for each web member 40 are vertically disposed within the cavity 38 in a substantially linear relationship. In an alternative design shown in FIGS. 5 and 10, the web member 40 includes five attachment points 44. The groupings of the attachment points 44 allow the side panels 20 and web members 40 to be cut horizontally over a wide range of heights to satisfy architectural requirements, such as leaving an area for windows and doors, yet still have at least two or three attachment points 44 to maintain structural integrity of the wall.

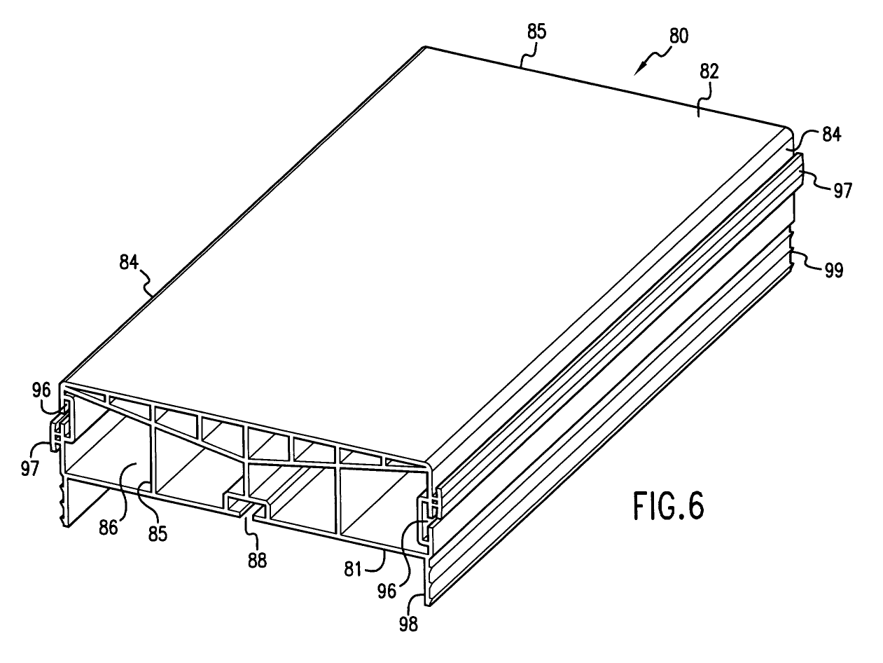

Such cuts into the side panels 20 or voids left in the walls relate to the present invention, which provides a buck system 70 for forming a frame 72 defining an opening within and through the wall as shown in FIGS. 6-9D. A desired structure, such as a window, hinged door, or garage door (not shown), is mounted within the frame 72 after the concrete is poured and substantially cures.

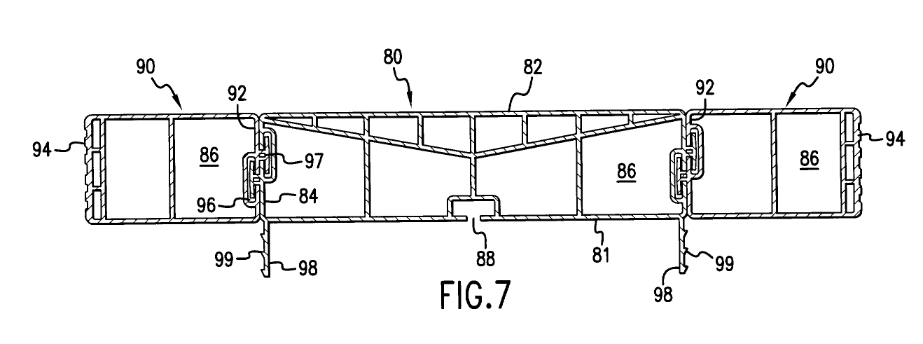

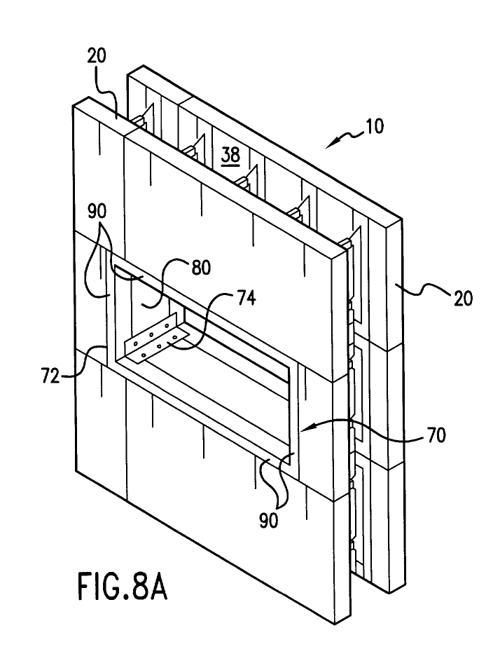

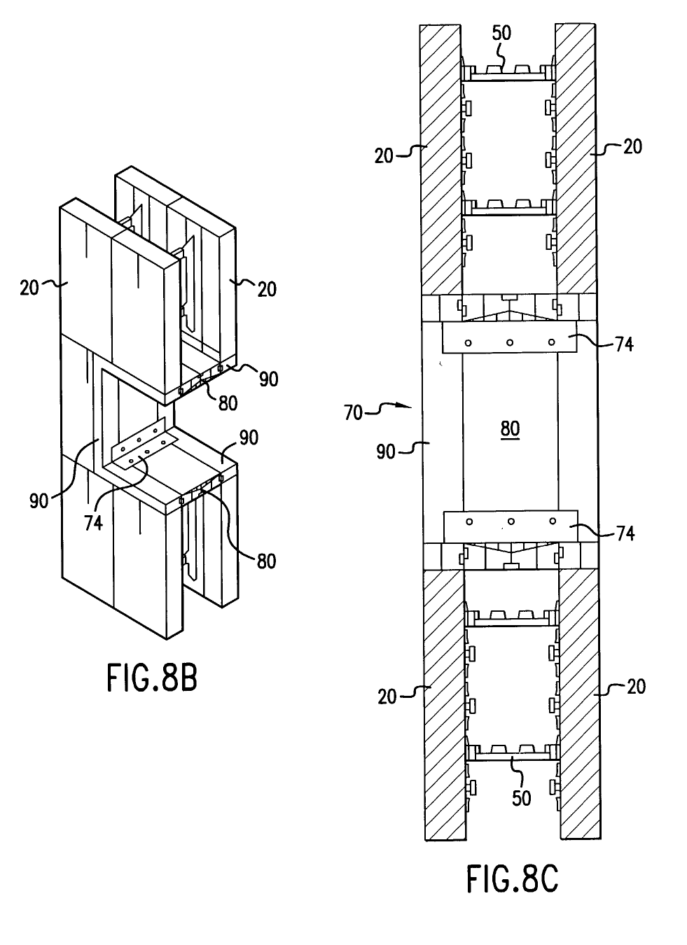

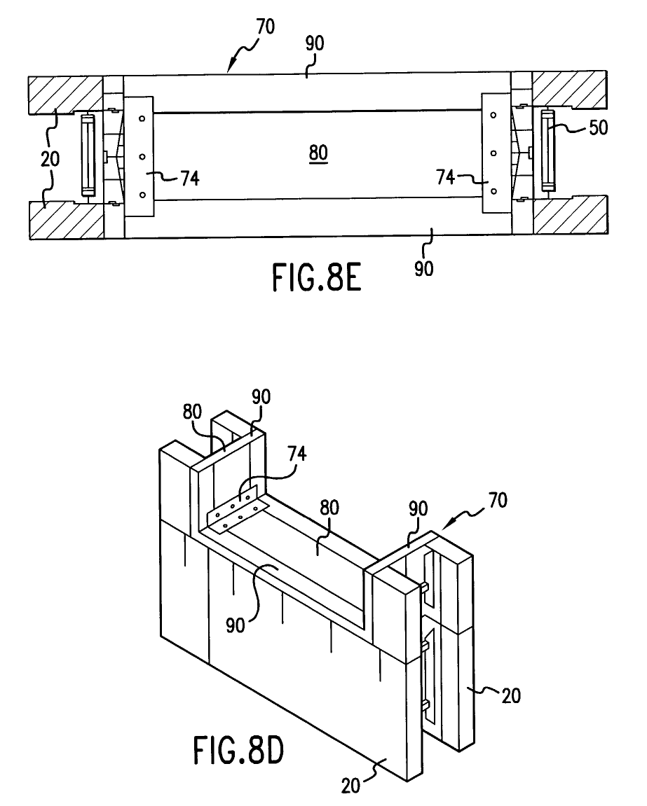

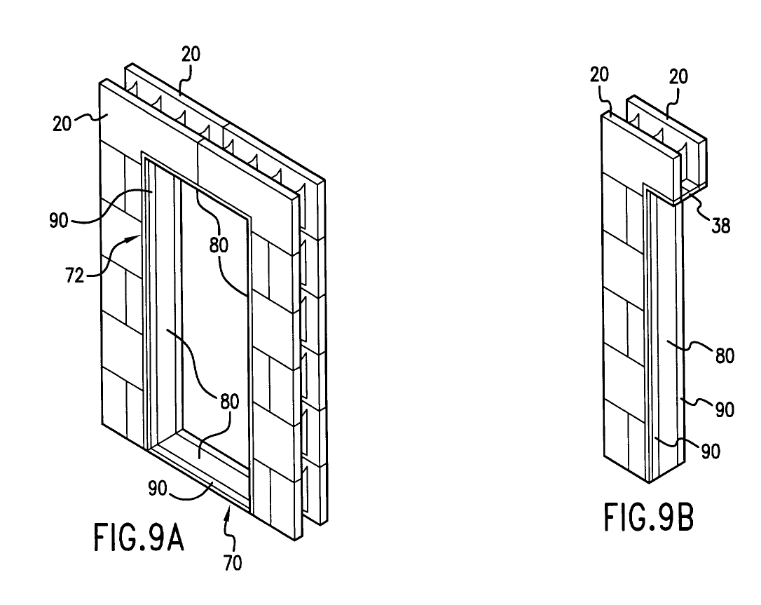

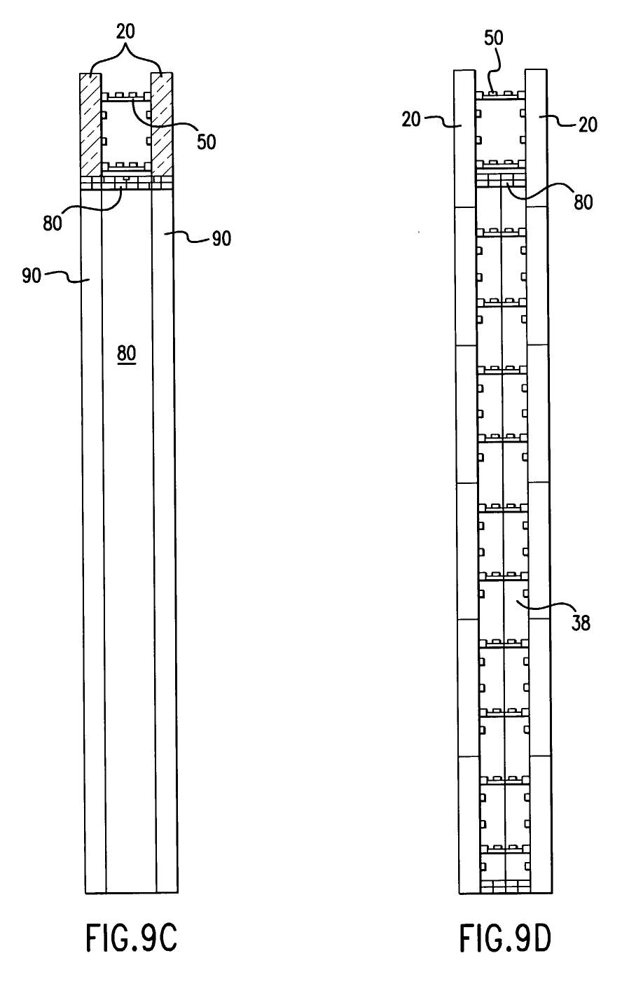

The buck system 70 forms a frame 72 using assembly members 80 and, in the preferred embodiment, also uses end caps 90 that are longitudinally aligned with and connected to the assembly members 80 forming the frame 72. As best shown in FIGS. 6 and 7, each assembly member 80 has an interior surface 81, an exterior surface 82, opposed sides 84, opposed ends 85, and a length extending between the opposed ends 85. In the preferred embodiment, at least three assembly members 80 are used in forming the frame 72, in which at least one end of each assembly member 80 is adjacent or abuts one end of another assembly member 80 to form a non-linear angle therebetween. In the context of the exemplary insulated concrete form described above and as discussed in more detail below, the frame 72 typically uses three assembly members 80 for a door, as shown in FIGS. 9B-9D, or includes four assembly members 80 for a window having its bottom ledge located above the subfloor on which the wall structure is disposed, as shown in FIGS. 8A-8E.

Referring now to FIG. 7, there is preferably at least one end cap 90 for each assembly member 80. Each end cap 90 has an engaging side 92 and an opposed exposed side 94. The engaging side 92 is designed to complementarily and detachably connect to one respective side of the assembly member 80. As shown in FIG. 7, there are two end caps 90 for each assembly member 80, each end cap 90 connected to one respective side 84 of one assembly member 80. It is further preferred that each end cap 90 has a length, in which the lengths of the end caps 90 are substantially the same as the assembly member 80 to which the end caps 90 are connected.

Referring back to FIGS. 6 and 7, it is preferred that each of the assembly members 80 and end caps 90 include a respective plurality of hollow channels 86 extending lengthwise within their respective inner volumes, the inner volume for the assembly members 80 defined by the interior and exterior surfaces 81, 82 and the opposed sides 84 (and the end caps 90 having a similarly defined inner volume). The channels 86 are aligned side by side, are formed to extend substantially the length of each assembly member 80, and may have a rectangular cross-section or other design, as show for example in FIG. 6. The channels 86 structurally strengthen the assembly members 80 without substantially increasing their cost or weight. If desired, the channels 86 may be selectively filled with insulating material that includes, for example, an expanded polyurethane foam, fiberglass materials, or any other similar material that increases thermal resistively through the frame 72.

Depending on the material used to form the components of the buck system 70, it may also be desired to construct the channels 86 in a “double walled” design adjacent surfaces through which fasteners (not shown), such as screws, are inserted. Specifically, referring to FIG. 7, the channels 86 adjacent the exposed side 94 of the end cap 90 has a small cross-sectional area so that a fastener traverses through at least two structural walls to provide a more secure and stable connection between the end cap 90 and the fastener. Likewise, the channels 86 adjacent the exterior surface 82 of the assembly member 80 also may use a relatively small cross-sectional area for the same purpose. Again, the channels 86 through which the fasteners traverse may take different cross-sectional shapes and may have different cross-sectional sizes, as demonstrated by the exemplary embodiments shown in the drawings.

Referring still to FIG. 7, to interconnect the engaging sides 92 of the end caps 90 to the sides 84 of the assembly members 80, preferably a connecting means is integrally formed into both respective surfaces. Still referring to FIGS. 6 and 7, each side of the assembly member 80 includes both a longitudinally-extending groove 96 and protrusion 97 and the associated engaging side 92 of the end cap 90 has a mirror image groove 96 and protrusion 97. Thus, as shown in FIG. 7, the protrusion 97 of each component is slidably received in the groove 96 of the adjacent component to interlock the end cap 90 to the assembly member 80. As discussed below, this design allows different widths of end caps 90 to be used with different widths of assembly members 80, contributing to the “modularity” of the present invention.

The connecting means, however, can take different forms than that shown in FIGS. 6 and 7. For example, there may be only one groove on one component and one protrusion on the other, as opposed to having both a groove and protrusion on the sides of both components. As another example, one of the components may include a series of longitudinally-aligned orifices and the other component may include spaced-apart longitudinally-aligned stems that are complementarily received within the orifices to engage and lock the components together. Still other connecting means are contemplated, such as chemically bonding using glue, fusing, mechanically connecting with fasteners, and the like. It is also contemplated integrally forming the assembly members 80 and end caps 90 together, although this is currently less desirable since it reduces the modularity of the design for use in different situations with different types of buildings.

As mentioned above, the preferred system of the present invention uses interchangeable components. Specifically, the width or depth between the opposed sides 84 of the assembly members 80 is preferably the same as that of the cavity 38 and the depth of the end caps 90 is correspondingly the same as that of the side panels 20. Thus, for the exemplary embodiment of the concrete form system discussed above, the end caps 90 are manufactured in two widths: two inches for commercial blocks (i.e, twenty-four inches in height with a thickness of two inches) and two and a half inches for residential blocks (i.e., sixteen inches height with a thickness of two and a half inches). The assembly members 80 may be used with either size side panels 20 so that the components are interchangeable for residential and commercial structures.

It is also contemplated in the preferred embodiment using, for example, both four (4) and six (6) inch wide assembly members 80. These assembly members 80 may be joined together using the connecting means to fit, for example, a twelve (12) or fourteen (14) inch thick concrete wall. In fact, with this design, the present invention may fit any thickness concrete wall in two-inch increments starting with a four-inch wide wall. Such a design and the interchangeable end caps 90 contribute to the modular concept that reduces manufacturing costs of the components of the present invention and allow the manufactured components to be used in numerous combinations of building designs. As one skilled in the art will appreciate, the contractor may select components of the desired dimensions for that wall design from a collection of materials and assemble those components at the construction site.

Referring again to FIGS. 6 and 7, another feature of the preferred embodiment of the present invention is the inclusion of at least one flange 98 for each assembly member 80. Each flange 98 extends from a portion of either the assembly member 80 or the adjacent connected end cap 90. As best shown in FIG. 7, there are two flanges 98 that are each integrally formed to one assembly member 80. The flanges 98 each have a contacting surface 99 that is serrated and is adapted to engage the interior surface 34 of the assembled side panels 20. As will also be discussed below, the spacing between the contacting surfaces 99 of the flanges 98—or the contacting surfaces 99 of the outermost flanges 98 if multiple assembly members 80 are laterally together to be a width wider than the described embodiment (i.e., eight inches)—are spaced apart the same width as the cavity 38. Thus, the contacting surfaces 99 of the flanges 98, which preferably include some lateral flexibility, are slid into the cavity 38 formed between the opposed side panels 20 to position stationarily the assembly member(s) 80 relative to the side panels 20. Stated differently, the flanges 98 frictionally engage the interior surface 34 of the side panels 20 to hold the assembly members 80 of the frame 72 in position.

One means to ensure that the flange 98 does not move relative to the side panel 20 during the pouring of the concrete is to use a fastener (not shown) to interconnect a portion of the flange 98 to a portion of the side panel 20. For example, the fastener may be a screw disposed through a portion of the flange 98 and the side panel 20, in which the screw is preferably a wood screw with wide threading. The fastener can also take the form of a chemical bonding substance, such as glue, or the like. As one skilled in the art will appreciate, use of a fastener is most prevalent when forming a structure having one side panel, such as a tilt-up wall disclosed in U.S. patent application Ser. No. 09/848,595.

Another option to position stationarily the assembly members 80 relative to the side panels 20 is using an extender attached to the slot formed in the assembly member 80. Still referring to FIGS. 6 and 7, the interior surface 81 of the assembly member 80 includes a longitudinally-extending slot 88 disposed intermediate its opposed sides 84 and the slot 88 is of a size to complementarily receive the tip end 62 of an extender 60, which is shown in FIGS. 5 and 10. The tip end 62 is preferably rectangular in plan view—as is the attachment point 44—and the base end 64 is similar in design to the end 52 of the connector 50. The tip end 62 is slid into the slot 88 of the assembly member 80.

The body 66 of the extender 60 defines a passage 68 therethrough. As will be noted by FIG. 5, the passage 68 is of a dimension to allow a portion of at least one flexible linking member 100, such as a zip-tie as shown in FIG. 10, plastic tie strap, tie wire, or other similar component, to be received therethrough. Since the assembly member 80 is oriented at a non-parallel angle to the interior and exterior surfaces 32, 34 of the side panels 20—specifically being disposed at right angle—the normally linear connectors 50 shown in FIG. 4 cannot feasibly be used. One skilled in the art will appreciate by referring to FIG. 10 that the extender 60 connected to the assembly member 80 within its slot 88 may be used with a flexible linking member 100 to provide a connection to the adjacent side panels 20. That is, the linking member 100 passing through the passage 68 of the extender 60 connected to the slot 88 of the assembly member 80 also connects either to another extender 60 attached to an attachment point 44 of one web member 40; to a slot 41 extending through the web member 40; and/or wrapped around a connector 50 interconnecting two opposed side panels 20 (not shown). Such a connection supports the frame 72 mounted against the side panels 20 as shown in FIGS. 8A-9D and buttresses the frictional hold of the flanges 98 and/or the external bracing (which is discussed in more detail below). Of course, other designs for the extender and the slot may be used within the scope of the present invention.

One skilled in the art will further appreciate that the extender 60 and the flexible linking member 100 additionally act as an “anchor” for the concrete. That is, the extender 60 and the flexible linking member 100 have surfaces that the fluid concrete surrounds as it is poured into the cavity 38 so that the cured concrete better holds the frame 72 in position after curing. Also, the slot 88 further or independently assists in anchoring the frame 72 to the cured concrete.

The assembly members 80, end caps 90, and flanges 98 are each preferably formed of a vinyl material that is extruded, most preferably polyvinyl chloride (“PVC”), which inherently has fire retardant characteristics. Vinyl materials are strong but not brittle, may be cleaned, and do not require painting or other preserving after installation when covered, which usually occurs for window and door bucks. However, the components may be formed from alternative materials including, for example, other vinyl-type materials, fiberglass, aluminum and its alloys, and other similar materials. Regardless of the material chosen, it is preferred to use a low cost material that is resistant to corrosion and decay, can accept nails or screws, yet have sufficient structural strength to support the forces applied by the fluid concrete when the wall is being formed.

One aspect of the present invention is that it functions almost the same as dimensional lumber with which construction workers are familiar. That is, the preferred material—similar to wood—may be made readily cut using a hand saw or hand held power saw and also may be nailed, screwed, or glued. PVC satisfies these requirements. In addition, in the preferred embodiment, the assembly members 80 and end caps 90 are provided in lengths of eight (8) feet, which is similar to the dimension that lumber is sold and used by construction workers.

As one skilled in the art will further appreciate, the components of the present invention may be easily stored before use because they are in a disassembled condition, reducing the amount of space necessary for shipment and storage at the construction site. Shipping dissembled components also minimizes potential damage that may occur during transportation to the construction site prior to installation.

During construction, the components are cut, if necessary, at the construction site to a desired length for the frame 72 to be formed. However, it is preferred that the assembly members 80 and end caps 90 be assembled prior to sawing, in which the components are longitudinally staggered, i.e., the ends 85 of the assembly members 80 are positioned so that they are approximately the midpoint of the length of end caps 90 and vice versa. Thus, a rigid, interlocking joint is formed as a result of this staggered positioning of the assembly members 80 and end caps 90. It is further preferred that the components further be chemically bonded together, such as with a PVC glue if the end caps and assembly members are formed of PVC. This design makes a strong assembled component and minimizes waste. For example, an entire construction may be completed with only a few unused remnants, a minimization of waste that other systems and dimensional lumber do not provide.

To install a window buck such as that shown in FIGS. 8A-8E, the side panels 20 are first positioned. Referring specifically FIG. 8A, each end of all four assembly members 80 and end caps 90 is adjacent or abuts a respective end of an adjacent corresponding component to form a ninety (90) degree angle to define a rectangular window frame 72. The window frame, accordingly, has a top, a bottom, and two opposed sides and, as illustrated, includes two end caps 90 attached to each of the respective four assembly members 80.

The window frame 72 formed from four assembly members 80 and eight end caps 90 as shown in FIG. 8A are positioned within and through the wall structure at a desired location and secured by a compression fit between the flanges 98 and the interior surface 34 of the side panels 20. That is, as noted above, the flanges 98 connected to the assembly member 80 or end caps 90 are spaced apart at substantially the same width as the depth or thickness of the cavity 38. Accordingly, the flanges 98 that are slightly flexible in the preferred embodiment bend inwardly when inserted into the cavity 38 so that the flanges 98 frictionally hold the frame 72 in position. The non-smooth, serrated contacting surfaces 99 of the flanges 98 assist in positioning the frame 72. If the web members 40 and their attachment points 44 interfere with the flanges 98 when inserted into the cavity 38, notches and other areas of the flange 98 can be trimmed away to accommodate the frame 72. As also discussed above, additional means may be used internally to position the frame 72 stationarily relative to the side panels 20, such as using the extenders 60 and flexible linking members 100 (which are not shown in FIGS. 8C and 8E) and/or fasteners between the side panels 20 and the flanges 98.

The bottom of the window frame 72, however, may optionally include only end caps 90 so that the cavity 38 adjacent the bottom is in free communication with the outside. That is, instead of having an assembly member 80 disposed between the cavity 38 and the outside environment, that assembly member is missing but the two bottom end caps 90 are used. These two bottom end caps 90, called stand-alone end caps, are disposed substantially horizontally and elevationally below the three assembly members 80. The length edges or engaging sides of the two stand-alone end caps are spaced apart from each other to provide a gap in the bottom of the window frame 72 that allows the cavity 38 to vent during placement of the concrete. This gap may be monitored to ensure that the concrete reaches the bottom of the window frame 72 and also may be used as a port through which concrete is poured into the cavity 38 during construction.

Referring now to FIGS. 9A-9D, the illustrated frame 72 is designed to receive a hinged door instead of a window as discussed above. Besides the changed dimensions, the primary difference is the use of the bottom portion of the frame 72. As shown in FIG. 9A, a bottom member is included in the frame 72. However, this bottom member may be either be temporary to function as bracing or be permanent. FIG. 9B shows the bottom member removed from the frame 72 after the concrete has substantially cured or set.

For a garage doorframe (not shown) that has an upper portion extending more than eight feet—the length of the assembly members 80 and the end caps 90 in the preferred embodiment—the components are preferably assembled staggered relative to each other and glued, as discussed above. This design using staggered joints forms a unitary solid plank and has desirable physical and structural strength characteristics. Alternatively, the assembly members 80 and end caps may be aligned to abut linearly end to end (i.e., in eight foot segments) and angle braces or other horizontal bracing devices interconnect each of the linearly abutting components to support their connection and prevent separation during placement of the concrete. These temporary supports are then removed after the concrete cures.

As illustrated, external bracing may also be used to support the frame 72 during installation. As shown in FIGS. 8A-8E, corner angle braces 74 may be included at each corner of the frame 72 and secured with drywall screws (not shown). Usually four corner angle braces 74 are sufficient for supporting a window or a hinged doorframe. However, if necessary (due to the weight of the concrete above), the frame 72 can be braced either horizontally or vertically across the opening with additional bracing if warranted. For example, bracing may be provided using in a conventional manner with one metal or wooden brace (not shown) used for approximately every three feet of opening.

After the side panels 20 and frames 72 are assembled, positioned, and braced, concrete is poured into the cavity 38 formed between the interior surfaces 34 of the side panels 20 and the interior surfaces 81 of the assembly members 80 to create the concrete wall. Once the concrete substantially cures or dries, any external bracing holding the frame 72 in position may be removed and then the window or door may be inserted into the frame 72.

Although the present invention has been described with reference to specific details of certain embodiments thereof, it is not intended that such details should be regarded as limitations upon the scope of the invention. For example, the buck system 70 of the present invention is discussed in context of the insulated form system described above; however, one skilled in the art will appreciate that the present invention can be used with other building systems and designs, e.g., the forms may be standard concrete wall forms or insulated concrete forms using designs different from the embodiment discussed herein.

What is claimed is:

1. A frame, comprising:
a. at least three assembly members, each assembly member having an interior surface, an exterior surface, opposed sides, and opposed ends, wherein at least one end of each assembly member is disposed adjacent one end of another assembly member to form a non-linear angle therebetween;
b. at least one end cap for each assembly member, each end cap having an engaging side and an opposed exposed side, the engaging side connected to one side of the assembly member; and
c. a flange associated with at least one assembly member, the flange extending from a portion of a selected one of that respective assembly member or the connected end cap, the flange adapted to engage a portion of a wall.

2. The frame of claim 1, wherein there is at least one flange associated with each assembly member.

3. The frame of claim 1, wherein there are two end caps connected to each assembly member, each end cap connected to one respective side of one assembly member.

4. The frame of claim 1, wherein each assembly member has a length extending between its opposed ends, wherein each end cap also has a length, and wherein the length of the assembly member is substantially the same as each connected end cap.

5. The frame of claim 1, wherein the assembly members and the end caps are formed of polyvinyl chloride.

6. The frame of claim 1, wherein one flange is integrally formed to each assembly member.

7. The frame of claim 1, wherein the flange is serrated in side view.

8. The frame of claim 1, wherein there are four assembly members and two end caps connected to each assembly member and wherein each of the two ends of each assembly member is disposed adjacent a respective end of an adjacent assembly member.

9. The frame of claim 1, further comprising at least one standalone end cap having opposed length edges that are spaced apart from the assembly members.

10. The frame of claim 9, wherein there are three assembly members, two end caps connected to each assembly member, and two stand-alone end caps, wherein the standalone end caps are disposed substantially horizontally and elevationally below the three assembly members, and wherein the length edges of the two stand-alone end caps are spaced apart from each other.

11. The frame of claim 1, wherein each assembly member includes an anchoring site disposed intermediate its opposed sides.

12. The frame of claim 11, wherein the anchoring site provides a point for attachment between the wall and the assembly member.

13. The frame of claim 12, further comprising an extender that is joined to the anchoring site and a flexible linking member interconnecting the wall and the extender.

14. The frame of claim 1, wherein the end cap is complementarily and detachably connected to the respective assembly member.

15. The frame of claim 1, wherein each assembly member is selected from a group of assembly members each having a different width extending between their respective opposed sides.

16. The frame of claim 15, wherein each end cap is selected from a group of end caps having a different width extending between their respective engaging and exposed sides.

17. The frame of claim 1, wherein each end cap is selected from a group of end caps having a different width extending between their respective engaging and exposed sides.

18. A wall structure, comprising:
a. a wall formed by two spaced-apart side panels, each side panel having an interior and an exterior surface, a cavity formed between the interior surfaces of the spaced-apart side panels;
b. at least three assembly members, each assembly member having an interior surface, an exterior surface, opposed sides, and opposed ends, wherein at least one end of each assembly member is disposed adjacent one end of another assembly member to form a non-linear angle therebetween;
c. at least one end cap for each assembly member, each end cap having an engaging side and an opposed exposed side, the engaging side connected to one side of the assembly member; and
d. a flange associated with at least one assembly member, the flange extending from a portion of a selected one of that respective assembly member or the connected end cap, the flange sized to engage a portion of the interior surface of a respective side panel.

19. The wall structure of claim 18, wherein each assembly member has a width extending between the opposed sides, the width being substantially the same dimension as the cavity of the wall.

20. The wall structure of claim 18, wherein each end cap has a width extending between the engaging and exposed sides, wherein each side panel has a thickness extending between the interior and exterior surfaces, and wherein the width of the end cap is substantially the same dimension as a thickness of the side panel.

21. The wall structure of claim 18, wherein there are two flanges joined to each respective assembly member, each flange adapted to engage respective interior surfaces of the spaced-apart side panels.

22. The wall structure of claim 18, wherein there are two end caps connected to each assembly member, each end cap connected to one respective side of one assembly member.

23. The wall structure of claim 18, wherein each assembly member has a length extending between its opposed ends, wherein each end cap also has a length, and wherein the length of the assembly member is substantially the same as each connected end cap.

24. The wall structure of claim 18, wherein the assembly members and the end caps are formed of polyvinyl chloride.

25. The wall structure of claim 18, wherein one flange is integrally formed to each assembly member.

26. The wall structure of claim 18, wherein the flange is serrated in side view.

27. The wall structure of claim 18, wherein there are four assembly members and two end caps connected to each assembly member and wherein each of the two ends of each assembly member is disposed adjacent a respective end of an adjacent assembly member.

28. The wall structure of claim 18, further comprising at least one stand-alone end cap having opposed length edges that are spaced apart from the assembly members.

29. The wall structure of claim 29, wherein there are three assembly members, two end caps connected to each assembly member, and two stand-alone end caps, wherein the stand-alone end caps are disposed substantially horizontally and elevationally below the three assembly members, and wherein the length edges of the two standalone end caps are spaced apart from each other so that the cavity of the wall is viewable therebetween.

30. The wall structure of claim 18, wherein each assembly member includes an anchoring site disposed intermediate its opposed sides.

31. The wall structure of claim 30, wherein the anchoring site provides a point for attachment between the wall and the assembly member.

32. The wall structure of claim 31, further comprising an extender that is joined to the anchoring site and a flexible linking member interconnecting the wall and the extender.

33. The wall structure of claim 18, wherein the end cap is complementarily and detachably connected to the respective assembly member.

34. The wall structure of claim 18, wherein each assembly member is selected from a group of assembly members each having a different width extending between their respective opposed sides.

35. The wall structure of claim 34, wherein each end cap is selected from a group of end caps having a different width extending between their respective engaging and exposed sides.

36. The wall structure of claim 18, wherein each end cap is selected from a group of end caps having a different width extending between their respective engaging and exposed sides.

37. The wall structure of claim 18, further comprising concrete within the cavity.

38. A method of building a wall structure, comprising:
a. positioning two side panels in a spaced apart relationship to form a cavity between respective interior surfaces thereof, each of the side panels having a thickness, the side panels each defining an opening in registry with the opening in the spaced apart side panel;
b. aligning a plurality of assembly members each having two end caps connected thereto within the respective openings of the side panels, a selected one of the assembly member or the end cap having a flange extending therefrom; and
c. inserting the flanges into the cavity so that the flanges contact respective interior surfaces of the side panels, so that each of the assembly members substantially span the cavity, and so that the end caps abut respective side panels, wherein the assembly members and end caps form a frame that at least partially circumscribes the opening.

39. The method of claim 38, wherein the end caps are slidingly mated with the assembly members after the side panels have been positioned and before the assembly members and the end caps are aligned with the openings.

40. The method of claim 38, wherein the side panels are disposed upright and further comprising pouring fluid concreted into at least a portion of the cavity after the frame at least partially circumscribes the opening.

41. The method of claim 38, further comprising bracing the assembly members prior to pouring the concrete.

42. The method of claim 38, wherein the openings are rectangular and the frame circumscribes at least three sides of the openings.
